(19) United States
(12) Patent Application Publication
(10) Pub. No.: US 2024/0069507 A1
(43) Pub. Date: Feb. 29, 2024

(54) SYSTEMS AND METHODS FOR DYNAMIC CURRENT LIMIT ADJUSTMENT

(71) Applicant: EXLAR CORPORATION, Chanhassen, MN (US)

(72) Inventor: Erik M. WIMME, Eden Prairie, MN (US)

(21) Appl. No.: 17/823,593

(22) Filed: Aug. 31, 2022

(51) Int. Cl. G05B 13/04

(52) U.S. Cl. CPC G05B 13/042

(57) ABSTRACT

Systems and methods disclosed herein include an integrated servo motor, a memory, and a processor. The processor may be configured to receive a plurality of system states. The processor may be configured to obtain temperature data of a plurality of components of the integrated servo motor based on the plurality of system states. The processor may be configured to monitor the temperature data for the plurality of components over a predetermined period of time. The processor may be configured to dynamically adjust, in response to the monitored temperature data for the plurality of components, a motor or phase current limit that is supplied to the integrated servo motor.

### TECHNICAL FIELD

The present disclosure relates to dynamic current adjustment, and more particularly, to systems and methods for dynamic current limit adjustment of integrated servo motors or servo motor drives.

### BACKGROUND

Presently, controlling the maximum current flow to a motor is limited by the rated or assumed maximum ambient temperature and speed of the motor. However, this makes it challenging to achieve optimal system performance, especially at low motor speeds, because the capabilities of the system cannot be improved above baseline specifications that are published and preset.

These and other deficiencies exist.

### BRIEF SUMMARY

Embodiments of the present disclosure provide current adjustment system including an integrated servo motor, a processor, and a memory. The processor may be configured to receive a plurality of system states. The processor may be configured to obtain temperature data of a plurality of components of the integrated servo motor based on the plurality of system states. The processor may be configured to monitor the temperature data for the plurality of components over a predetermined period of time. The processor may be configured to dynamically adjust, in response to the monitored temperature data for the plurality of components, a motor or phase current limit that is applied to the integrated servo motor.

Embodiments of the present disclosure provide a method of current adjustment. The method may include receiving, by a processor, a plurality of system states. The method may include obtaining, by the processor, temperature data of a plurality of components of an integrated servo motor based on the plurality of system states. The method may include monitoring, by the processor, the temperature data for the plurality of components over a predetermined period of time. The method may include dynamically adjusting, by the processor and in response to the monitored temperature data for the plurality of components, a motor or phase current limit that is applied to the integrated servo motor.

### BRIEF DESCRIPTION OF THE DRAWINGS

FIG. 1A is a schematic of a current adjustment system according to an example embodiment,

FIG. 1B is a schematic of a current adjustment system according to another example embodiment, and

FIG. 2 depicts a method of current adjustment according to an example embodiment.

### DETAILED DESCRIPTION

The following description of embodiments provides non-limiting representative examples referencing numerals to particularly describe features and teachings of different aspects of the invention. The embodiments described are capable of implementation separately, or in combination, with other embodiments from the description of the embodiments. A person of ordinary skill in the art reviewing the description of embodiments is able to learn and understand the different described aspects of the invention. The description of embodiments facilitates understanding of the invention to such an extent that other implementations, not specifically covered but within the knowledge of a person of skill in the art having read the description of embodiments, would be understood to be consistent with an application of the invention.

Presently, an actuator that is involved in a pressing process may compress with a great amount of force for a short period of time using a significant amount of current. The actuator then must move quickly to set up for the next pressing routine. High-speed pressing processes tend to generate heat via the rotary to linear motion translational screw and drive input current, whereas during high torque or pressing processes the three-phase inverter and motor windings will generate the majority of the heat.

In contrast, the systems and methods disclosed herein are implemented to evaluate the overall heat contribution from each component of an actuator and then set the current limit to a value that may be outside of the standard operational limits of the system. In particular, a microprocessor may be configured to dynamically adjust a current limit, such as the motor or phase current limit, that may be applied to, for example and without limitation, an integrated servo motor, a servo motor drive, an actuator or the like, based on a plurality of monitored system states. Although reference may be made to the integrated servo motor, it is understood that the disclosure herein is not limited to such and that it may refer to the servo motor drive or the actuator or the like. The microprocessor may be configured to monitor, determine, or predict the temperature of various components of the integrated servo motor, the servo motor drive, the actuator that limit the capability thereof because of the heat that they generate. Once the critical component temperatures are known, either through direct measurement or independent derivation, control of the integrated servo motor and drive, such as the motor or phase current limit of the motor, may be adjusted to increase motor performance. This implementation may consequently yield an increase of 80% improvement in performance of the motor.

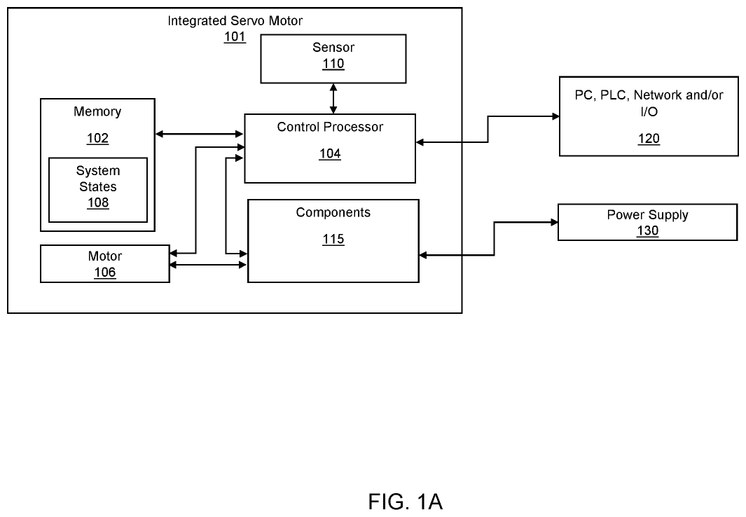

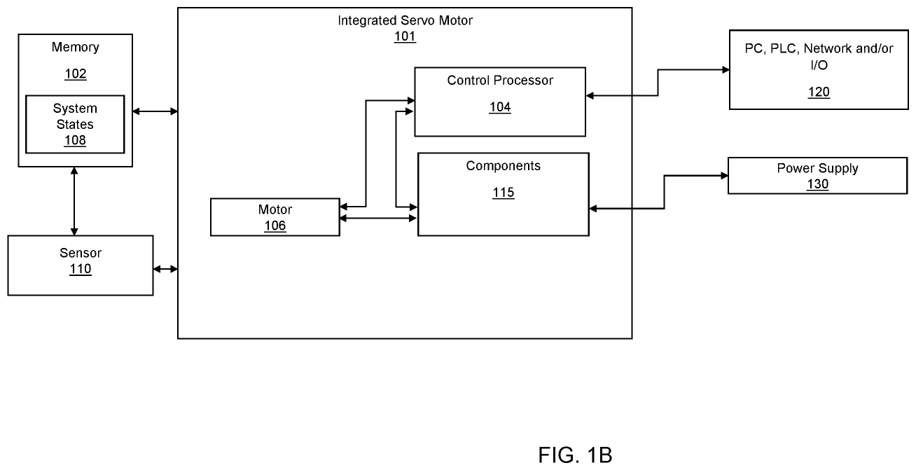

FIG. 1A is a schematic of an integrated servo motor 101 that may be connected to a personal computer, a programmable logic controller, network, and/or input/output interface 120, and a power supply 130 according to an exemplary embodiment. Although FIG. 1A illustrates single instances of the components, any number of the components is contemplated.

The integrated servo motor 101 may include a memory 102, a processor 104, a motor 106, one or more sensors 110, and a plurality of components 115. In some examples, the memory 102 may be a read-only memory, write-once read-multiple memory or read/write memory, e.g., RAM, ROM, and EEPROM, and the integrated servo motor 101 may include one or more of these memories 102. A read-only memory may be factory programmable as read-only or one-time programmable. One-time programmability provides the opportunity to write once then read many times. A write once/read-multiple memory may be programmed at a point in time after the memory chip 102 has left the factory. Once the memory 102 is programmed, it may not be rewritten, but it may be read many times. A read/write memory may be programmed and re-programed many times after leaving the factory. It may also be read many times. The memory 102 may be configured to store temperature data. In addition, the memory 102 may be configured to store a plurality of system states 108. While the memory 102 is depicted in FIG. 1A as being internal to the integrated servo motor 101, the memory 102 is depicted in FIG. 1B as being external to the integrated servo motor 101, as discussed below. It is understood that the processing circuitry of the processor 104 may contain additional components, including processors, memories, error and parity/CRC checkers, data encoders, anticollision algorithms, controllers, command decoders, security primitives and tamper-proofing hardware, as necessary to perform the functions described herein.

The plurality of system states 108 may include at least one or more selected from the group of an input voltage such as either AC or DC, an ambient temperature, motor speed that may be captured through an encoder-type device, motor torque, input current between the drive and power supply 130 or wall jack, motor current between the drive and motor 106, user or factory defined firmware setup parameters, such as a user-defined parameter or limit to prevent excessive torque from being applied due to dynamic current limit, and/or any combination thereof. In some examples, the memory 102 may be configured to store the plurality of system states 108. As discussed below, the plurality of system states 108 may be captured by one or more sensors 110. The plurality of system states 108 may include those other than critical component temperatures, and may be configured to determine or predict the critical component temperatures.

The processor 104, such as a control processor, may be configured to receive temperature data of the plurality of components 115. Without limitation, the plurality of components 115 may include a first component, a second component, etc. of an integrated servo motor 101. As further discussed below, the processor 104 may be configured to receive the temperature data of the plurality of components 115 via one or more sensors 110. The processor 104 may be configured to dynamically adjust the current applied to the integrated servo motor 101 based on the foregoing information, as further discussed below. Without limitation, the processor 104 and memory 102 may be configured to store device firmware, control parameters, operational limits, and user-defined parameters.

Without limitation, the motor 106 may comprise any motor suitable for the integrated servo motor 101, and may be controlled by the processor 104.

The one or more sensors 110 may include devices, such as temperature sensors, encoders, hall sensors, resolvers, current sensors, voltage sensors, piezo force sensors, and/or any combination thereof. For example, the one or more sensors 110 may be located on any circuit board within the integrated servo motor 101 or servo motor drive housing and/or on any of the plurality of components 115 and/or in a location where, in data communication with the processor 104, they may be configured to sufficiently observe or sense any of the plurality of system states 108 that are useful to determine the temperatures of the plurality of components 115. In some examples, the one or more sensors 110 may be directly connected to the processor 104, for example and without limitation by analog signals, serial peripheral interfaces, inter-integrated circuits, or analog-to-digital converters, or any other communication standard. Other communication standards such as EtherCAT, controller area network, 4-20 mA current loop may be utilized.

The plurality of components 115 may include any number of components. Without limitation, the plurality of components of the integrated servo motor 101 may comprise current limiters, chokes, rectifiers, inverters, current sensors, motor windings, inductors, bus capacitors, voltage regulators, and/or any combination thereof. In some examples, the plurality of components 115 may refer to critical components, such as those components that limit performance of the integrated servo motor 101. In some examples, the plurality of components 115 may be those that, when temperature testing is done, are the closest to their respective rated or listed limits at peak operation conditions. For example, the plurality of components 115 may be those that get the closest to their rated maximum temperature values when operating at full speed, full torque, or any combination thereof.

The personal computer 120 may be a network-enabled computer. In addition, the personal computer 120 may be in data communication with, and internal or external to a PLC, a network, and/or an input/output interface, and also these components may be collectively or individually configured for setup, and also to control how and when the integrated servo motor 101 runs. The personal computer 120 may be operatively coupled to the integrated servo motor 101. As referred to herein, a network-enabled computer may include, but is not limited to a computer device, or communications device including, e.g., a server, a network appliance, a workstation, a phone, a handheld PC, a personal digital assistant, a thin client, a fat client, an Internet browser, or other device. The personal computer 120 also may be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device. In addition, the personal computer 120 may be configured to the integrated servo motor 101 via one or more networks (not shown). The network may be in data communication with any of the elements of the integrated servo motor 101, including but not limited to the memory 102, processor 104, motor 106, sensor 110, and/or plurality of components 115. In some examples, the network may be one or more of a wireless network, a wired network or any combination of wireless network and wired network. For example, the network may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or the like. In addition, the network may include, without limitation, telephone lines, fiber optics, IEEE Ethernet 902.3, a wide area network, a wireless personal area network, a LAN, or a global network such as the Internet. In addition, the network may support an Internet network, a wireless communication network, a cellular network, or the like, or any combination thereof. The network may further include one network, or any number of the exemplary types of networks mentioned above, operating as a stand-alone network or in cooperation with each other. The network may utilize one or more protocols of one or more network elements to which they are communicatively coupled. The network may translate to or from other protocols to one or more protocols of network devices. Although the network may be depicted as a single network, it should be appreciated that according to one or more examples, the network may comprise a plurality of interconnected networks, such as, for example, the Internet, a service provider's network, a cable television network, corporate networks, such as credit card association networks, and home networks.

The personal computer 120 may further include a display and input devices. The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into the user's device that is available and supported by the user's device, such as a touch-screen, keyboard, mouse, cursor-control device, push buttons and switches, microphone, digital camera, video recorder or camcorder. These devices may be used to enter information and interact with the software and other devices described herein.

The power supply 130 may include, without limitation, any type of power supply or the like input to the integrated servo motor 101. The power supply 130 may be operatively coupled to the integrated servo motor 101.

The processor 104 may be configured to receive the temperature data of the plurality of components 115 of the integrated servo motor 101 via one or more sensors 110 that are configured to measure the temperature data.

In substitute of, or in addition to the above, the processor 104 may be configured to derive the temperature data of the plurality of components 115 of the integrated servo motor 101 based on application of one or more models including a predictive algorithm, predictive learning model, a control model, such a Linear Quadratic Gaussian, and/or any combination thereof. For example, the one or more models may be trained using a dataset that includes temperature data for each of the plurality of components 115 of the integrated servo motor 101, which then may be trained to recognize how often to monitor the temperature data for each of the plurality of components 115 relative to a threshold value. In this manner, the one or more models may be configured to continuously acquire temperature data such that it is trained to generate one or more predictions based on assembling patterns of comparison of the temperature data of the plurality of components 115 to a threshold value of that same component 115 in order to determine whether or not to dynamically adjust the current limit, such as the motor or phase current limit, to a value that is applied to the integrated servo motor 101. In some examples, one or more controller schemes, such as linear quadratic regulator controllers, linear quadratic with integral controllers, linear quadratic gaussian controllers, Kalman filters, as well as other non-linear models, and/or any combination thereof, may be configured to modify the current limit to maintain the temperature of the respective critical component below their absolute maximum allowed temperature. These state space models may be configured for weighing of inputs, accounting for system noise, and determining the critical component temperatures through use of control observers and the one or more sensors 110. In some examples, one or more machine learning models may be used.

The processor 104 may be configured to monitor the temperature data for the plurality of components 115 of the integrated servo motor 101 over a predetermined period of time. In some examples, the processor 104 may be configured to continuously monitor the temperature data for the plurality of components 115 of the integrated servo motor 101. In other examples, the processor 104 may be configured to discretely monitor the temperature data for the plurality of components 115 of the integrated servo motor 101. In some examples, the processor 104 may be configured to evaluate the heat contribution from any combination of the plurality of components 115 of the integrated servo motor 101. In other examples, the processor 104 may be configured to evaluate the heat contribution from a specific set of the plurality of components 115 of the integrated servo motor 101. For example, the processor 104 may be configured to identify one or more components selected from the plurality of components 115 of the integrated servo motor 101 that restrict the capability of the integrated servo motor 101 due to increased motor speed. Such plurality of components 115 may include, without limitation, one or more of current limiters, chokes, filter capacitors, rectifiers, inverters, current sensors, motor windings, inductors, bus capacitors, voltage regulators and/or any combination thereof. For example, an inrush current limiter may prevent excess current at startup and dissipate significant power during use. For example, the choke may include at least one selected from the group of audio frequency choke, radio frequency choke, and common-mode choke. For example, the rectifier may include at least one selected from the group of a single-phase and/or a three-phase rectifier, which may be uncontrolled, half-controlled, or full controlled, and half-wave, full wave, or full bridge.

Further, the processor 104 may be configured to identify one or more components selected from the plurality of components 115 of the integrated servo motor 101 that restrict the capability thereof due to increased motor current and/or torque. Such plurality of components 115 may include, without limitation, inverters and/or current sensors. For example, the inverters may comprise multi-phase, such as three-phase inverters, which are configured to drive a motor coil, such as via a semiconductor switch including an insulated gate bipolar transistor, MOSFET, or other solid state switching device.

The processor 104 may be configured to monitor, determine, or predict the temperature data for a first component of the plurality of components 115, such as a rectifier, and compare it to a first threshold value to yield a first outcome. For example, the comparison by the processor 104 may yield the first outcome that is indicative of whether the temperature data of the first component is greater than or equal to a first threshold value. If the first outcome indicates that the temperature data of the first component is greater than or equal to a first threshold value, then the processor 104 may be configured to adjust, such as decrement, in real-time, a current limit, such as the motor or phase current limit, until the actual, projected or predicted temperature of the first component is below the first threshold value. In this manner, the temperature of the first component of the integrated servo motor 101 may be kept below the rated temperature of first component so as to protect the integrity of the integrated servo motor 101 as a whole. In some examples, and without limitation, protecting the integrity of the integrated servo motor 101 may refer to preventing the servo motor drive from reporting a temperature fault, wearing out, failing early, and/or any combination thereof. This is due to the dynamic adjustment of the current limit value, such as the motor or phase current limit value, as further discussed below. Alternatively, if the first outcome indicates that the temperature data of the first component is less than the first threshold value, then the processor 104 may be configured to adjust, such as increment, in real-time, the current limit value up to a user-defined or factory-defined value that may be significantly higher than the default current limit. This allows the user to utilize an increased torque/force/motor current range to provide increased capability when the critical component temperatures are below their rated maximum. The temperature data of the first component may be continuously or discretely monitored, determined, or predicted, until the temperature data of the first component exceeds or is equal to the first threshold value. Without limitation, and by way of example, an update rate of the current limit value may be configured by the processor 104 to be updated at 1 millisecond (ms) intervals or faster. In some examples, the update rate of the current limit value may be adjusted, such as slowed down to larger intervals, in order to account for processing power, such as low or reduced power availability.

Similarly, the processor 104 may also be configured to monitor or predict the temperature data for a second component of the plurality of components 115, such as an inverter, and compare it to a second threshold value to yield a second outcome. For example, the comparison by the processor 104 may yield the second outcome that is indicative of whether the temperature data of the second component is greater than or equal to a second threshold value. If the second outcome indicates that the temperature data of the second component is greater than or equal to a second threshold value, then the processor 104 may be configured to adjust, such as decrement, in real-time, the maximum current that may be applied to the integrated servo motor 101 until the actual, projected or predicted temperature of the second component is below the second threshold value. In this manner, the temperature of the second component of the integrated servo motor 101 may be kept below the rated temperature of second component so as to protect the integrity of the integrated servo motor 101 as a whole. In some examples, and without limitation, protecting the integrity of the integrated servo motor 101 may refer to preventing the servo motor drive from reporting a temperature fault, wearing out, failing early, and/or any combination thereof. This is due to the dynamic adjustment of the current limit value, such as the motor or phase current limit, as further discussed below. Alternatively, if the second outcome indicates that the temperature data of the second component is less than the second threshold value, then the processor 104 may be configured to adjust, such as increment, in real-time, the current limit value up to a user-defined or factory-defined value that may be significantly higher than the default current limit. This allows the user to utilize an increased torque/force/motor current range to provide increased capability when the critical component temperatures are below their rated maximum. The temperature data of the second component may be continuously or discretely monitored, determined, or predicted, until the temperature data of the second component exceeds or is equal to the second threshold value.

The processor 104 may be configured to dynamically adjust, in response to the monitored temperature data for the plurality of components 115 of the integrated servo motor 101, a current limit, such as the motor or phase current limit, that is applied thereto. Once the temperature data of the plurality of components 115 is continuously or discretely monitored, determined, or predicted over the predetermined period of time and/or referenced to a given value, such as a factory provided threshold value, the processor 104 may be configured to control the motor or phase current limit of integrated servo motor 101 in order to increase performance thereof and thereby improve operational efficiency of the integrated servo motor 101. Thus, the processor 104 may be configured to dynamically adjust the current limit, such as the motor or phase current limit, based on the one or more outcomes, as previously described. For example, to the extent that the temperature data of any plurality of components 115 of the integrated servo motor 101 are measured, determined, or predicted to be running at a cool temperature or below a threshold value, such as either at during start-up or during operation of the integrated servo motor 101, the current limit, such as the motor or phase current limit, may be increased by the processor 104 such that the temperature data of the plurality of components 115 are running at or greater than the threshold value.

Based on the evaluation of the heat contribution from each of the plurality of components 115 of the integrated servo motor 101, the processor 104 may be configured to set the current limit, such as the motor or phase current limit, to a value that may be outside the standard operational limit of the integrated servo motor 101. Consequently, at least an 80% improvement in performance of the integrated servo motor 101 may be achieved. For example, the dynamically adjusted current limit, such as the motor or phase current limit, may exceed a rated current limit of the integrated servo motor 101. The motor or phase current limit, for example, may be in part determined by the measured ambient temperature of the environment where the integrated servo motor is located. In this manner, the integrated servo motor 101 is not limited to efficiency based on the assumed maximum ambient temperature or motor speed. In some examples, the processor 104 may be further configured to update the current limit, such as the motor or phase current limit, at a predetermined rate, as discussed above. In other examples, the processor 104 may be further configured to update the current limit, such as the motor or phase current limit, at a user-defined rate. In some examples, the current limit may be updated by the processor 104 in order to account for processing power, such as low or reduced power availability.

In particular, the systems and methods disclosed herein may be integrated in any number of applications, including but not limited to, pressing operations, dispensing operations, valve seating, and welding.

FIG. 1B is a schematic of an integrated servo motor 101 that may be connected to a personal computer, a programmable logic controller, network, and/or input/output interface 120, and a power supply 130 according to another exemplary embodiment. Although FIG. 1B illustrates single instances of the components, any number of components is contemplated.

As further illustrated in FIG. 1B, the integrated servo motor 101 may refer to the any of the components and functionality as described above with respect to FIG. 1A, however the plurality of system states 108 may be transmitted to the one or more sensors 110 that are located external to the integrated servo motor 101. In some examples, the plurality of system states 108 may be transmitted to the integrated servo motor 101, such as to the processor 104. In some examples, the plurality of system states 108 may be contained with memory 102, the memory 102 being external to the integrated servo motor 101. In other examples, at least one or more sensors 110 may be located external to the integrated servo motor 101, and at least one or more different or same sensors 110 may be located internal to the integrated servo motor 101. In yet other examples, the memory 102, which may include the plurality of system states 108, and/or the one or more sensors 110 may be located external to integrated servo motor 101.

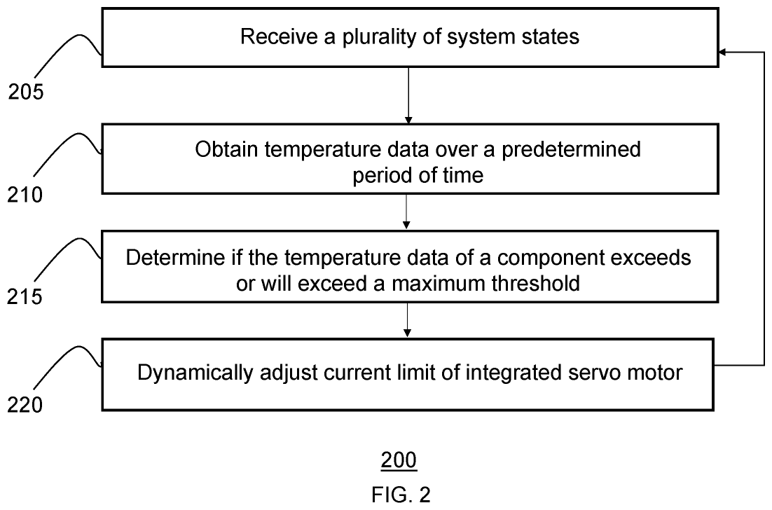

FIG. 2 illustrates a method 200 of current adjustment 200, according to an example embodiment. The method of FIG. 2 may reference and incorporate any components described above with respect to FIGS. 1A-1B.

At block 205, a processor may be configured to receive a plurality of system states. For example, the processor may be a part of an integrated servo motor and coupled to a memory. For example, the processor may be configured to receive the plurality of system states of an integrated servo motor via one or more sensors. The plurality of system states may include at least one or more selected from the group of an input voltage, such as either AC or DC, an ambient temperature, motor speed, motor torque, input current, motor current, user or factor defined firmware setup parameters, and/or any combination thereof. The one or more sensors may include temperature sensors, encoders, hall sensors, resolvers, current sensors, voltage sensors, piezo force sensors, and/or any combination thereof. For example, the one or more sensors may be located on any circuit board within the integrated servo motor or servo motor drive housing and/or on any of a plurality of components of the integrated servo motor and/or in a location where, in data communication with the processor, they may be configured to sufficiently observe or sense of the plurality of system states that are useful to determine the temperatures of the critical components. Without limitation, the plurality of components of the integrated servo motor may comprise current limiters, chokes, rectifiers, inverters, current sensors, motor windings, inductors, bus capacitors, voltage regulators, and/or any combination thereof. As explained above, the one or more sensors, which may be configured to transmit the plurality of states to the integrated servo motor, may be located internal, external, and/or any combination thereof relative to the integrated servo motor.

At block 210, the processor may be configured to obtain temperature data over a predetermined period of time. For example, the processor may be configured to obtain the temperature data of a plurality of components of the integrated servo motor based on the plurality of system states. As discussed above, the processor may be configured to obtain the temperature data for the critical components by, for example, through direct measurement or independent derivation. In some examples, the processor may be configured to receive the temperature data of a plurality of components of the integrated servo motor via the one or more sensors that are configured to measure the temperature data. In substitute of, or in addition to the above, the processor may be configured to derive the temperature data of the plurality of components of the integrated servo motor based on application of one or more models, including but not limited to a predictive algorithm, a predictive learning model, a control model, such a Linear Quadratic Gaussian, and/or any combination thereof. For example, the one or more models may be trained using a dataset that includes temperature data for each of the plurality of components of the integrated servo motor, which then may be trained to recognize how often to monitor the temperature data for each component relative to a threshold value. In this manner, the one or more models may be configured to continuously acquire temperature data such that it is trained to generate one or more predictions based on assembling patterns of comparison of the temperature data of a component to a threshold value of that same component in order to determine whether or not to dynamically adjust the current limit, such as the motor or phase current limit, to a value that is applied to the integrated servo motor. In some examples, one or more controller schemes, such as linear quadratic regulator controllers, linear quadratic with integral controllers, linear quadratic gaussian controllers, Kalman filters, as well as other non-linear models, and/or any combination thereof, may be configured to modify the current limit to maintain the temperature of the respective critical component below their absolute maximum allowed temperature. These state space models may be configured for weighting of inputs, accounting for system noise, and determining the critical component temperatures through use of control observers and the one or more sensors. In some examples, one or more machine learning models may be used.

In some examples, the processor may be configured to monitor the temperature data for the plurality of components of the integrated servo motor over a predetermined period of time. In some examples, the processor may be configured to continuously monitor the temperature data for the plurality of components of the integrated servo motor. In other examples, the processor may be configured to discretely monitor the temperature data for the plurality of components of the integrated servo motor. In some examples, the processor may be configured evaluate the heat contribution from any combination of the plurality of system states and/or components of the integrated servo motor. In other examples, the processor may be configured to evaluate the heat contribution from a specific set of the plurality of components of the integrated servo motor. For example, the processor may be configured to identify one or more components selected from the plurality of components of the integrated servo motor that restrict the capability thereof due to, without limitation, increased motor speed. Such components may include, without limitation, one or more of current limiters, chokes, filter capacitors, rectifiers, inverters, current sensors, motor windings, inductors, bus capacitors, voltage regulators and/or any combination thereof. For example, an inrush current limiter may prevent excess current at startup and cause a significant amount of voltage or power during use. For example, the choke may include at least one selected from the group of audio frequency choke, radio frequency choke, and common-mode choke. For example, the rectifier may include at least one selected from the group of a single-phase and/or a three-phase rectifier, which may be uncontrolled, half-controlled, or full controlled, and half-wave, full wave, or full bridge.

Further, the processor may be configured to identify one or more components selected from the plurality of components of the integrated servo motor that restrict the capability thereof due to increased motor torque or current. Such components may include, without limitation, inverters and/or current sensors. For example, the inverters may comprise multi-phase, such as three-phase inverters, which are configured to drive a motor coil, such as via a semiconductor switch including an insulated gate bipolar transistor.

At block 215, the processor may be configured to determine if the temperature data of a component exceeds or will exceed a maximum threshold. For example, the processor may be configured to monitor, determine, or predict the temperature data for a first component, such as a rectifier, and compare it to a first threshold value to yield a first outcome. For example, the comparison by the processor may yield the first outcome that is indicative of whether the temperature data of the first component is greater than or equal to a first threshold value. If the first outcome indicates that the temperature data of the first component is greater than or equal to a first threshold value, then the processor may be configured to adjust, such as decrement, in real-time, a current limit, such as the motor or phase current limit until the actual, projected, or predicted temperature of the first component is below the first threshold value. In this manner, the temperature of the first component of the integrated servo motor may be kept below the rated temperature of the first component so as to protect the integrity of the integrated servo motor as a whole. In some examples, and without limitation, protecting the integrity of the integrated servo motor may refer to preventing the servo motor drive from reporting a temperature fault, wearing out, failing early, and/or any combination thereof. This is due to the dynamic adjustment of the current limit value, such as the motor or phase current limit, as further discussed below. Alternatively, if the first outcome indicates that the temperature data of the first component is less than the first threshold value, then the processor may be configured to adjust, such as increment, in real-time, the current limit value up to a user-defined value or factory-defined value that may be significantly higher than the default current limit. This allows the user to utilize an increased torque/force/motor current range to provide increased capability when the critical component temperatures are below their rated maximum. The temperature data of the first component may be continuously or discretely monitored, determined, or predicted, until the temperature data of the first component exceeds or is equal to the first threshold value. Without limitation, and by way of example, an update rate of the current limit value may be configured by the processor to be updated at 1 millisecond (ms) intervals or faster. In some examples, the update rate of the current limit value may be adjusted, such as slowed down to larger intervals, in order to account for processing power, such as low or reduced power availability, in one or more applications as disclosed herein.

Similarly, the processor may also be configured to monitor, determine, or predict the temperature data for a second component, such as an inverter, and compare it to a second threshold value to yield a second outcome. For example, the comparison by the processor may yield the second outcome that is indicative of whether or not the temperature data of the second component is greater than or equal to a second threshold value. If the second outcome indicates that the temperature data of the second component is greater than or equal to a second threshold value, then the processor may be configured to adjust, such as decrement in real-time, a current limit, such as the motor or phase current limit, to a value that may be applied to the integrated servo motor until the actual, projected, or predicted temperature of the second component is below the second threshold value. In this manner, the temperature of the second component of the integrated servo motor may be kept below the rated temperature of the second component so as to protect the integrity of the integrated servo motor as a whole. In some examples, and without limitation, protecting the integrity of the integrated servo motor may refer to preventing the servo motor drive from reporting a temperature fault, wearing out, failing early, and/or any combination thereof. This is due to the dynamic adjustment of the current limit value, such as the motor or phase current limit, as further discussed below. Alternatively, if the second outcome indicates that the temperature data of the second component is less than the second threshold value, then the processor may be configured to continue to adjust, such as increment, in real-time, the current limit value up to a user-defined value or factory-defined value that may be significantly higher than the default current limit. This allows the user to utilize an increased torque/force/motor current range to provide increased capability when the critical component temperatures are below their rated maximum. The temperature data of the second component may be continuously or discretely monitored, determined, or predicted, the temperature data of the second component exceeds or is equal to the second threshold value.

At block 220, the processor may be configured to dynamically adjust, in response to the monitored temperature data for the plurality of components of the integrated servo motor, a current limit, such as the motor or phase current limit, that is applied thereto. Once the temperature data of the plurality of components is continuously or discretely monitored, determined, or predicted over the predetermined period of time and/or referenced to a given value, such as a factory-provided threshold value, the processor may be configured to control the motor or phase current limit of the integrated servo motor in order to increase performance thereof and thereby improve operational efficiency of the integrated servo motor. Thus, the processor may be configured to dynamically adjust the current limit, such as the motor or phase current limit, based on the one or more outcomes, as previously described. For example, to the extent that the temperature data of any plurality of components of the integrated servo motor are measured, determined, or predicted to be running at a cool temperature or below a threshold value, such as either during start-up or during operation of the integrated servo motor, the current limit, such as the motor or phase current limit, may be increased by the processor such that the temperature data of the plurality of components is measured, determined, or predicted to be at or greater than the threshold value.

Based on the evaluation of the heat contribution from each of the plurality of components of the integrated servo motor, the processor may be configured to set the current limit, such as the motor or phase current limit, to a value that may be outside the standard operational limit of the integrated servo motor. Consequently, at least an 80% improvement in performance of the integrated servo motor may be achieved. For example, the dynamically adjusted current limit, such as the motor or phase current limit, may exceed a rated current limit of the integrated servo motor. The motor or phase current limit, for example, may be in part determined by the measured ambient temperature of the environment where the integrated servo motor is located. In this manner, the integrated servo motor is not limited to efficiency based on the assumed maximum ambient temperature or speed. In some examples, the processor may be further configured to update the current limit, such as the motor or phase current limit, at a predetermined rate. In other examples, the processor may be further configured to update the current limit, such as the motor or phase current limit, at a user-defined rate. In some examples, the current limit may be updated by the processor in order to account for processing power, such as low or reduced power availability, in one or more applications as disclosed herein.

In particular, the systems and methods disclosed herein may be integrated in any number of applications, including but not limited to, pressing operations, dispensing operations, valve seating, and welding.

Throughout the specification and the claims, the following terms take at least the meanings explicitly associated herein, unless the context clearly dictates otherwise. The term “or” is intended to mean an inclusive “or.” Further, the terms “a,” “an,” and “the” are intended to mean one or more unless specified otherwise or clear from the context to be directed to a singular form.

In this description, numerous specific details have been set forth. It is to be understood, however, that implementations of the disclosed technology may be practiced without these specific details. In other instances, well-known methods, structures and techniques have not been shown in detail in order not to obscure an understanding of this description. References to “some examples,” “other examples,” “one example,” “an example,” “various examples,” “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrases “in one example,” “in one embodiment,” or “in one implementation” does not necessarily refer to the same example, embodiment, or implementation, although it may.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, including the best mode, and also to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system comprising:
an integrated servo motor;
a memory; and
a processor, wherein the processor is configured to:
receive a plurality of system states;
obtain temperature data of a plurality of components of the integrated servo motor based on the plurality of system states;
monitor the temperature data for the plurality of components over a predetermined period of time; and
dynamically adjust, in response to the monitored temperature data for the plurality of components, a motor or phase current limit that is applied to the integrated servo motor.

2. The system of claim 1, wherein the processor is further configured to update the motor or phase current limit at a predetermined rate.

3. The system of claim 1, wherein the processor is further configured to predict the temperature data based on application of one or more algorithms.

4. The system of claim 1, wherein the plurality of system states include at least one or more selected from the group of an input voltage, an ambient temperature, motor speed, motor current, or motor torque.

5. The system of claim 1, further comprising one or more sensors that are configured to measure the temperature data, and wherein the processor is configured to receive the temperature data from the one or more sensors.

6. The system of claim 1, wherein the processor is further configured to continuously monitor the temperature data for the plurality of components over the predetermined period of time.

7. The system of claim 1, wherein the processor is further configured to identify at least one component of the integrated servo motor that exceeds a predetermined temperature threshold due to increased motor speed.

8. The system of claim 1, wherein the processor is further configured to identify at least one component of the integrated servo motor that exceeds a predetermined temperature threshold due to increased motor torque.

9. The system of claim 1, wherein the processor is further configured to apply the dynamically adjusted motor or phase current limit to limit current that is supplied to, or through, at least one component of the integrated servo motor based on an identification of the at least one component that exceeds a predetermined temperature threshold due to one or more of increased motor speed or increased motor torque or increased motor current.

10. The system of claim 1, wherein the processor is further configured to update the motor or phase current limit at a user-defined rate.

11. The system of claim 1, wherein the integrated servo motor is configured to connect to at least one selected from the group of a personal computer or a power supply.

12. A method of current adjustment comprising:
receiving, by a processor, a plurality of system states;
obtaining, by the processor, temperature data of a plurality of components of an integrated servo motor based on the plurality of system states;
monitoring, by the processor, the temperature data for the plurality of components over a predetermined period of time; and
dynamically adjusting, by the processor and in response to the monitored temperature data for the plurality of components, a motor or phase current limit that is applied to the integrated servo motor.

13. The method of claim 12, further comprising updating, by the processor, the motor or phase current limit at a predetermined rate.

14. The method of claim 12, further comprising predicting, by the processor, the temperature data based on application of one or more algorithms.

15. The method of claim 12, wherein the plurality of system states include at least one or more selected from the group of an input voltage, an ambient temperature, motor speed, motor current, or motor torque.

16. The method of claim 12, further comprising identifying, by the processor, at least one component of the integrated servo motor that exceeds a predetermined temperature threshold due to increased motor speed.

17. The method of claim 12, further comprising identifying, by the processor, at least one component of the integrated servo motor that exceeds a predetermined temperature threshold due to increased motor torque.

18. The method of claim 12, further comprising updating, by the processor, the motor or phase current limit at a user-defined rate.

19. The method of claim 12, wherein the motor or phase current limit exceeds a rated current limit of the integrated servo motor.

20. The method of claim 12, further comprising discretely monitoring, by the processor, the temperature data for the plurality of components over the predetermined period of time.
